(19) United States
(12) Patent Application Publication
(10) Pub. No.: US 2023/0107298 A1
(43) Pub. Date: Apr. 6, 2023

(54) FOLDING CUTTING MAT

(71) Applicant: Chi-Jen CHEN, Xihu Township (TW)

(72) Inventor: Chi-Jen CHEN, Xihu Township (TW)

(21) Appl. No.: 17/493,480

(22) Filed: Oct. 4, 2021

(51) Int. Cl. B26D 7/20

(52) U.S. Cl. CPC B26D 7/20

(57) ABSTRACT

A folding cutting mat having a first and second side boards and a flexible connecting plate. The first and second side boards respectively include a cutting surface, a back surface and a waved joining edge. The first and second side boards are connected to each other through the waved joining edges to form a folding portion. The flexible connecting plate is bonded on the back surfaces of the first and second side boards through a bonding material. The waved joining edge is formed with first and second end sides. A plurality of unit blocks is formed between the first and second ends in continuous and staggered distributions. A center line is defined between the first and second ends to divide each of the unit blocks into first and second surface areas. The distribution area of the bonding material covers the second surface areas of each of the unit blocks.

### CROSS-REFERENCE TO RELATED U.S. APPLICATIONS Not applicable.

### BACKGROUND OF THE INVENTION

### 1. Field of the Invention

The present invention relates generally to a folding cutting mat, and more particularly to an innovative structural design featuring uniform and smooth joint of the foldable portions and enhanced performance.

### 2. Description of Related Art Including Information Disclosed Under 37 CFR 1.97 and 37 CFR 1.98

The folding cutting mat mentioned in the present invention specifically refers to a cutting mat with the folding and joining portion of its two cutting surfaces designed in the form of a waved seam. The back surfaces of the two cutting surfaces are usually bonded with a hard plastic connecting board. The purpose of such a design is to effectively avoid the situation wherein when the cutter slides across the cutting surface, the movement path of the cutter may just coincide with the folding seam and the edge of the cutter may sink into the folding seam, and cut apart the hard plastic connecting board.

In actual applications, it is found that the conventional folding cutting mat also has other problems. For example, as shown in FIG. 10, the bonding material distribution areas 83 on the back surfaces of the hard plastic connecting board 80 and the two cutting boards 81, 82 usually do not cover the folding and joining portions 84 in the above-mentioned form of a waved seam. The bonding material distribution area is usually in the form of a long straight strip. However, based on different bonding materials, the bonding material distribution area may have different thicknesses. (Note: As the prior art usually uses double-sided tapes for bonding, there is a considerable increase of thickness, causing unevenness of the cutting surface. When the user drags the cutter to slide across the cutting surface, the cutter may slip to hurt the cutter because of the uneven cutting surface.) As the bonding material distribution area 83 does not cover the folding and joining portions 84 in the form of a waved seam, there is a long stripe-shaped area with completely no bonding thickness at the position of the folding and joining portions 84 in the form of a waved seam. As a result, when the user drags the cutter to slide across the cutting surface, in case the cutter passes the strip-shaped area with no bonding thickness, the user will feel the collapse or unevenness, which will affect the stability and safety during the cutting operation. Moreover, this stripe-shaped area with no bonding thickness will inevitably affect the strength of bonding between the folding and joining portions 84 and the hard plastic connecting board 80, leading to gradual separation and affecting the durability and life cycle of the folding cutting mat.

### BRIEF SUMMARY OF THE INVENTION

The main object of the invention is to provide a folding cutting mat. It aims to make an innovative breakthrough in solving the technical problems by developing a practically ideal new-style folding cutting mat.

Based on the above object, the present invention provides a folding cutting mat, comprising a first side board, a second side board, and a flexible connecting plate. The first side board and the second side board respectively comprise a cutting surface, a back surface and a waved joining edge. The first side board and the second side board are connected to each other through the waved joining edges to form a folding portion. The flexible connecting plate is bonded on the back surfaces of the first side board and the second side board through a bonding material, with the area of the flexible connecting plate covering the waved joining edges. Based on the varying wave points of the waved joining edge, a first end and a second end are defined. Between the first end and the second end, a plurality of unit blocks is defined, in a continuous and staggered distribution. A center line is defined between the first end and the second end, dividing each of the unit blocks into a first surface area and a second surface area. Specifically, the distribution range of the bonding material covers the second surface areas of the unit blocks, whereas the first surface areas of the unit blocks are not covered by the bonding material and can turn upward.

Based on the above innovative structural design and technical features, the present invention makes an improvement over the prior art to enhance the uniformity and bonding area of the bonding material around the folding portion, and consequently enhances the flatness and smoothness of the folding portion on the cutting surface, so as to greatly enhance the stability and accuracy during the cutting operation. Furthermore, because the distribution area of the bonding material is considerably increased comparing to the prior art, the bonding strength between the folding portion and the flexible connecting plate can be effective increased to reduce the possibility of separation. Thus, the folding cutting mat can have better durability and longer life cycle.

### BRIEF DESCRIPTION OF THE SEVERAL VIEWS OF THE DRAWINGS

FIG. 1 is a front-side perspective view of a preferred embodiment of the folding cutting mat according to the invention.

FIG. 2 is a back-side perspective view of a preferred embodiment of the folding cutting mat according to the invention.

FIG. 3 is an exploded perspective view of the flexible connecting plate, the first side board, and the second side board in a preferred embodiment of the folding cutting mat according to the invention.

FIG. 4 is a plane view showing the distribution range of bonding material around the folding portion of preferred embodiment of the folding cutting mat according to the invention.

FIG. 5 is an enlarged view of the part marked as 5 in FIG. 4.

FIG. 6 is a first perspective view of the folded state of a preferred embodiment of the folding cutting mat according to the invention.

FIG. 7 is a second perspective view of the folded state of a preferred embodiment of the folding cutting mat according to the invention.

FIG. 8 is a first varied embodiment view of the waved joining edge according to the invention.

FIG. 9 is a second varied embodiment view of the waved joining edge according to the invention.

FIG. 10 is a plane view of the partial structure of a prior-art folding cutting mat.

### DETAILED DESCRIPTION OF THE INVENTION

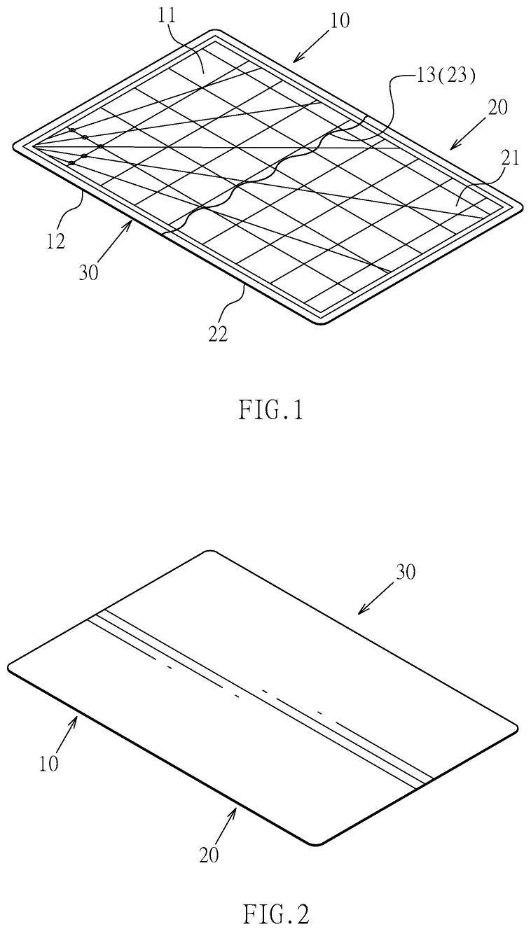

A preferred embodiment of the folding cutting mat according to the invention is depicted in FIG. 1 to FIG. 4. However, such an embodiment is for illustrative purposes only, and is not intending to limit the scope of patent protection for the invention.

The folding cutting mat comprises a first side board 10, a second side board 20 and a flexible connecting plate 30. The first side board 10 and the second side board 20 respectively comprises a cutting surface 11 (21), a back surface 12 (22) and a waved joining edge 13 (23). The first side board 10 and the second side board 20 are connected to each other through the waved joining edges 13 (23) to form a folding portion. The flexible connecting plate 30 is bonded on the back surface 12 (22) of the first side board 10 and the second side board 20 through a bonding material 40, with the area of the flexible connecting plate 30 covering the waved joining edges 13 (23). Based on the varying wave points of the waved joining edge 13 (23), a first end 50 and a second end 60 are defined. Between the first end 50 and the second end 60, a plurality of unit blocks 70 is defined, in a continuous and staggered distribution. A center line 73 is defined between the first end 50 and the second end 60, dividing each of the unit blocks 70 into a first surface area 71 and a second surface area 72. Specifically, the distribution range of the bonding material 40 covers the second surface areas 72 of the unit blocks 70, whereas the first surface areas 71 of the unit blocks 70 are not covered by the bonding material 40 and can turn upward. Thus, the bonding material 40 is evenly distributed around the folding portion with a sufficient covering area.

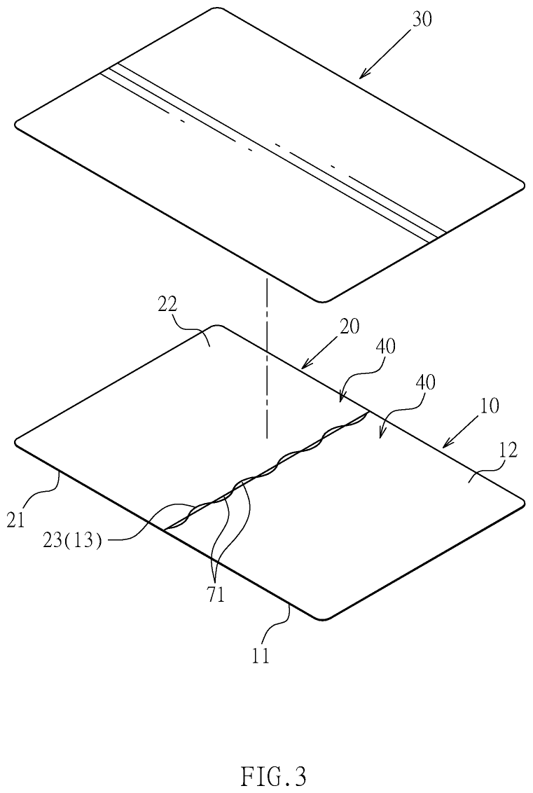

Referring to FIG. 3, in the present embodiment, the area contour of the flexible connecting plate 30 matches (or conforms to) the area contour of the back surfaces 12 (22) of the first side board and the second side board 10, 20. Further, the flexible connecting plate 30 can also be a soft non-slip material (such as TPE or thermoplastic elastomer) to achieve better smoothness and anti-slip performance of the folding cutting mat. When the user uses a cutter to conduct a pulling and cutting operation, as the folding cutting mat is flat and smooth and will not slip, it is more stable and safe to avoid accidental hurt.

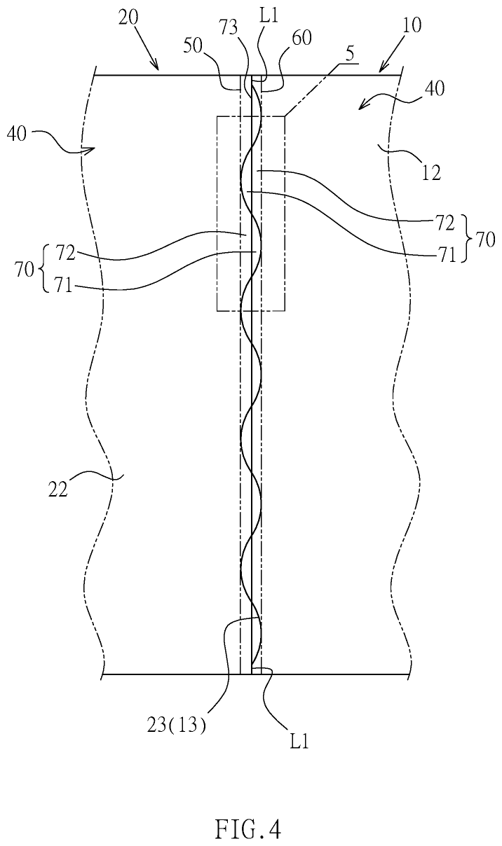

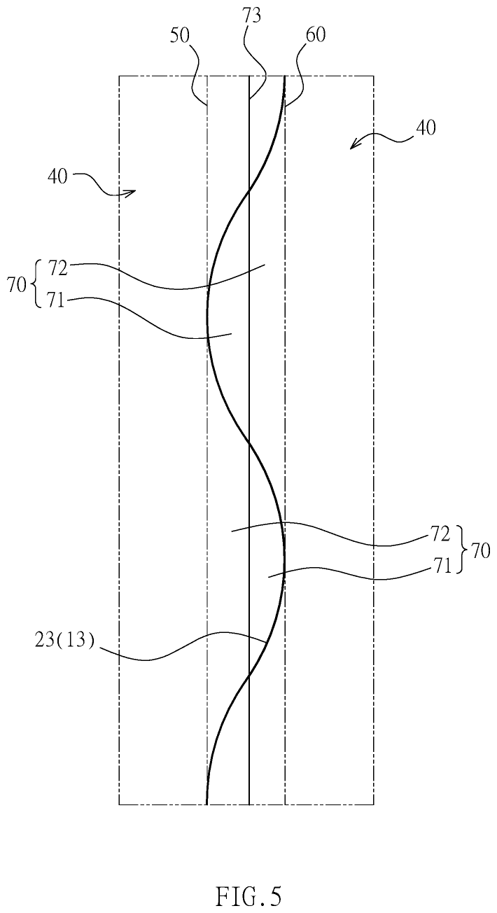

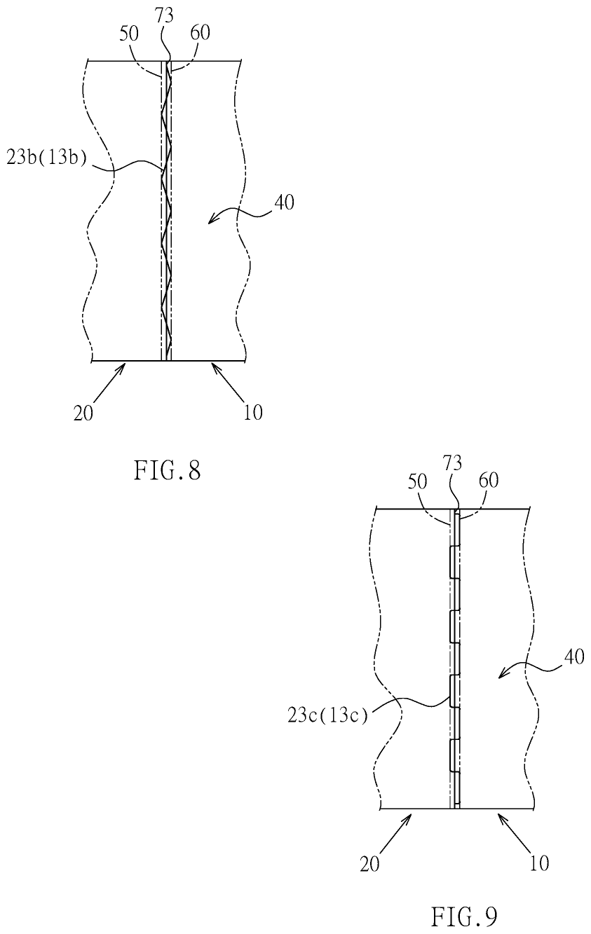

Specifically, the line form of the waved joining edge 13 (23) is a waved line formed by any of arc line segments, oblique line segments or straight line segments distributed in a continuous bending form. Firstly referring to FIG. 4 and FIG. 5, in this embodiment, the line form of the waved joining edge 13 (23) is a waved line formed by arc line segments distributed in a continuous bending form. Further referring to FIG. 8, in this embodiment, the line form of the waved joining edge 13b (23b) is a waved line formed by oblique line segments distributed in a continuous bending form. Further referring to FIG. 9, in this embodiment, the line form of the waved joining edge 13c (23c) is a waved line formed by straight line segments distributed in a continuous bending form. Of course, other forms not depicted in the drawings and similar or close to the above line forms can be easily conceived by those skilled in the art and are naturally covered by the patent protection range of the present invention, although not detailed here one by one.

Specifically, said bonding material 40 refers to glues (such as sprayed glues or coated glues), adhesive materials (such as double-side adhesive tapes), or hot molten portions formed by high frequency or ultrasonic means.

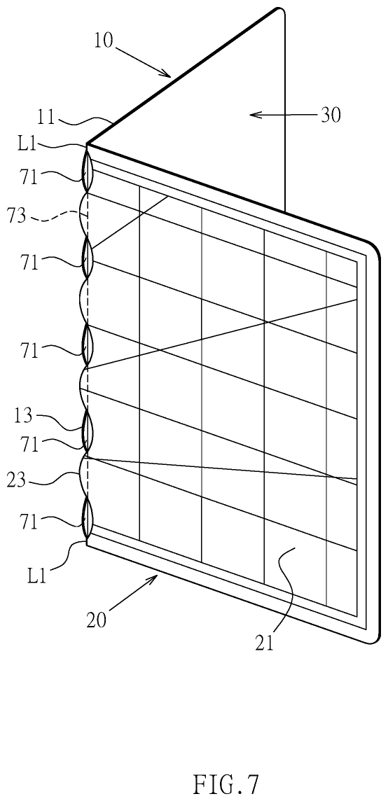

Referring to FIG. 4 and FIG. 7, in this embodiment, the opposite two ends of the waved joining edges 13 (23) are adjacent to the edges of the first side board 10 and the second side board 20, and are formed with two straight line segments L1 aligned and parallel to the center line 73; based on the structural characteristic of the straight line segments L1, when the first side board 10 and the second side board 20 are folded, (see FIG. 7), the edges will be straight and smooth, free of burrs.

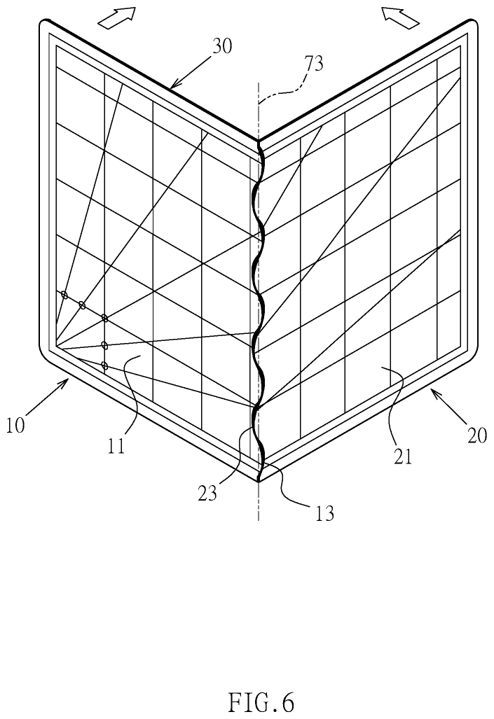

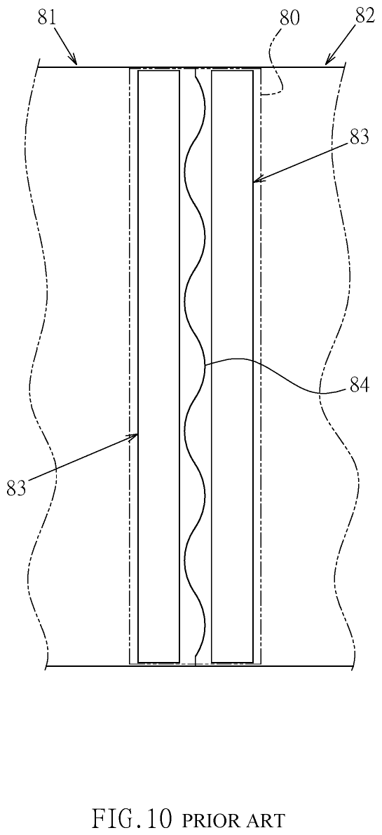

Based on the above structural forms and technical features, the folding cutting mat of the present invention offers a number of benefits in actual applications. According to the invention, the distribution range of the bonding material 40 covers the second surface areas 72 of each of the unit blocks 70, whereas the first surface areas 71 are not covered by the bonding material 40 and can turn upward. Therefore, when the folding cutting mat is folded in a state as shown in FIG. 6 and FIG. 7, a bending will occur between the first side board 10 and the second side board 20, with the center line 73 of the folding portion as the axis. At this time, the first surface areas 71 with no distribution of bonding material 40 will relatively turn upward, so that the first side board 10 and the second side board 20 can be fully folded together face to face; on the other hand, when the first side board 10 and the second side board 20 are unfolded to form a flat usage state as shown in FIG. 1, the state of each first surface area 71 with no distribution of bonding material 40 are depicted in FIG. 3. There is only a plurality of discontinuously distributed narrow blocks. Even though there is difference in thickness, the feeling of sinking when the user slides the cutter across the cutting mat is reduced to the minimum (comparing to the prior art disclosed in FIG. 10). Therefore, the present invention can truly improve the uniformity and bonding area of the bonding material 40 around the folding portion, and improve the flatness of the folding portion of the cutting surface 11 (21), therefore greatly enhancing the stability and accuracy of the cutting operation. Furthermore, as the bonding area is much bigger than the prior art, the bonding strength between the folding portion and the flexible connecting plate 30 can be effectively increased to reduce the possibility of separation. Thus, the folding cutting mat can have better durability and longer life cycle.

1. (canceled)

2. (canceled)

3. (canceled)

4. (canceled)

5. (canceled)

6. A folding cutting mat comprising:
a first side board;
a second side board; and
a flexible connecting plate, wherein said first side board and said second side board respectively comprise a cutting surface and a back surface and a wavy joining edge, said first side board and said second side board being connected by the wavy joining edge to form a folding portion, said flexible connecting plate being bonded by a bonding material on the back surface of said first side board and the second side board, said flexible connecting plate covering the wavy joining edge, wherein the wavy joining edge defines a first end and a second end, a plurality of unit blocks being positioned between the first end and the second end in a continuous and staggered distribution, the first end and the second end defining a center line therebetween, the center line dividing each of the plurality of unit blocks into a first surface area and a second surface area, wherein a distribution of the bonding material covers the second surface area of the plurality of unit blocks, wherein the first surface area of the plurality of unit blocks is not covered by the bonding material.

7. The folding cutting mat of claim 6, wherein said flexible connecting plate has a contour conforming to a contour of the back surface of the first side board and the second side board.

8. The folding cutting mat of claim 6, wherein the wavy joining edge is formed by one of an arc line segment, an oblique line segments and a segment distributed in a continuously bending form.

9. The folding cutting mat of claim 6, wherein opposite ends of the wavy joining edge are adjacent to edges of said first side board and said second side board, the opposite ends of the wavy joining edge are in a form of a pair of straight line segments aligned with and parallel to the center line.
